(19) United States
(12) Patent Application Publication
(10) Pub. No.: US 2013/0144974 A1
(43) Pub. Date: Jun. 6, 2013

(54) METHOD AND SYSTEM FOR FACILITATING PUSH NOTIFICATION

(71) Applicant: Notice Software LLC, Austin, TX (US)

(72) Inventors: Casey Anderson Haakenson, Hamburg (DE); Burton Thomas Edward Miller, Seattle, WA (US); Leonard Wayne Vore, Austin, TX (US)

(73) Assignee: NOTICE SOFTWARE LLC, Austin, TX (US)

(21) Appl. No.: 13/691,153

(22) Filed: Nov. 30, 2012

Related U.S. Application Data
(60) Provisional application No. 61/566,303, filed on Dec. 2, 2011.

(51) Int. Cl. H04L 29/08

(52) U.S. Cl. CPC H04L 67/26
USPC 709/217

(57) ABSTRACT

Techniques for sending push notifications from Websites and consuming them in a browser on a mobile device are described. A native mobile component acts as a bridge during registration, receipt, and consumption of the push notifications. An Internet service acts as a registration and relaying mechanism to pass data to the native mobile component. When a push notification is consumed, the user is directed to the specified URL in a browser on the mobile device rather than a native application.

### PRIORITY CLAIM

This application claims the benefit of U.S. Provisional Application Ser. No. 61/566,303, entitled “METHOD AND SYSTEM FOR SENDING PUSH NOTIFICATION” and filed Dec. 2, 2011.

### FIELD OF THE INVENTION

The invention relates generally to a method and system for facilitating push notifications and, more specifically, for sending push notifications to and from non-native mobile components using a native mobile bridging component and pre-configuration of this native component using a generic mechanism.

### BACKGROUND OF THE INVENTION

Websites cannot send push notifications to mobile devices. Native components of mobile devices have the ability to register for and receive notifications of new content as it becomes available. This feature is lacking for the Web and is a very desirable feature for a Website in order to maintain readership and compete for users in the modern mobile world. Websites have no access to the push notification registration pathway that mobile native components can access and hence cannot initiate the process of configuring the mobile devices for receipt of push notifications.

Websites have no long-running abilities beyond when a page is closed. There exist approaches that involve attempting to open network sockets or other channels to transmit push data while the page is still open. However, these approaches are incapable of delivering push notifications when the page or browser is closed, or when the browsing device is powered off or lacking service. These approaches are neither capable of delivering push notifications when the browser is closed nor queuing notifications until the device is on or has regained service.

In addition, native components or applications are not pre-configurable. When a user is directed to download a native application, the application comes in a single variant. The configuration data for the native application is pre-determined and cannot be dynamically pre-configured at the time of download or installation, based on the user's context, how the user initiated the download, or other factors. As a specific example, using existing approaches, it is not possible to have the same native component downloaded and installed on multiple different users' devices and have it configured to receive push notifications from different sets of originators based on the context in which the installation was initiated. For example, it is not possible to download the same application from two different Websites and have each application be pre-configured to receive notifications from the Website from which it was downloaded.

Furthermore, current push notification technologies exist only on the native side. Web pages do not run in the background or have any communication channels (e.g., sockets) to the user except when the user is actively on the Web page. Push notification technologies are exclusive to native components running on mobile devices.

For an application to be configured using existing techniques, the general approach is to have user settings stored on a server and have the user login to the application once it is installed. This approach thus relies on post-configuration based on user action, instead of pre-configuration. Since pre-configured native components are not possible using existing techniques, native components rely on the user to configure the component or re-login using Website credentials post-install. This results in a diminished user experience and acts as a barrier to usage.

### SUMMARY OF THE INVENTION

Embodiments include a method and system for sending push notifications from Websites and consuming them in a browser on a mobile device. A native mobile component acts as a bridge during registration, receipt, and consumption of the push notifications. An Internet service acts as a registration and relaying mechanism to pass data to the native mobile component. When a push notification is consumed, the user is directed to the specified URL in a browser on the mobile device not, as would happen with prior art, a native application.

Alternative embodiments of the present invention include a method and system for pre-configuring native mobile components as part of a registration process for Web-based push notifications. Information is stored in a cookie or locally by at least one of the operating system, a mobile app store application, other native user-space or operating system component, or the like.

### BRIEF DESCRIPTION OF THE DRAWINGS

Preferred and alternative examples of the present invention are described in detail below and with reference to the drawings accompanying the application submission:

FIG. 1 is a block diagram of an example embodiment of a mobile notification facilitator;

FIGS. 2A and 2B illustrate existing approaches to registration and transmission of push notification;

FIGS. 3A-3C depict registration processes according to example embodiments;

FIGS. 4A-4C depict pre-configuration processes according to example embodiments;

FIG. 5 depicts a push notification process according to an example embodiment; and

FIG. 6 is a block diagram of an example computing system for implementing a mobile notification facilitator according to an example embodiment.

### DETAILED DESCRIPTION

The described techniques enable the registration-for, origination-of, relaying-of, and consumption-of push notifications originating from the Web and resulting in the consumption of an originator's content without requiring the originator to have a custom native component installed on a user's device. Instead of a custom native component that is tailored to a specific content provider, a shared native component (also called a “bridge” or “bridging component”) may be used. In some embodiments, the bridging component is a separate native application or module that a user downloads and installs. In other embodiments, the bridging component is pre-installed on the user's device, incorporated into the operating system of the user's device, part of a Web browser executing on the user's device, or by any combination of the above-mentioned methods with or without server assistance.

In some embodiments, the techniques include a pre-configuration process that facilitates the installation and configuration of a native app or component with no or minimal interaction required from a user. In one example embodiment, a user may click on a link on a Website, or a UI element such as a button that's part of the browser interface while viewing a website, to initiate installation of an app. The link may contain or identify configuration information that is automatically passed by the user's browser, app store app, or other system component to the app upon installation and/or initial execution of the app. For example, the link may include embedded arguments that are stored by the browser, app store app, or other system component during installation and then, upon initial execution of the app, passed to the app via a uniform resource locator, a callback, or other mechanism. Such pre-configuration techniques may be employed in fields or contexts other than that of push notification. Specifically, they may be employed to perform automatic configuration of apps or other kinds of software modules installed onto any kinds of computing devices or systems.

Typical embodiments employ the described techniques in the context of mobile devices, such as smart phones, tablet computers, personal digital assistants, and the like. However, the described techniques are not limited to the mobile context. In particular, they may also be employed in the special-purpose or embedded device context, including smart televisions, smart appliances (e.g., Internet-enabled refrigerators), media streaming/access devices, home entertainment systems, vehicle-based navigation or entertainment systems, and the like. Furthermore, the described techniques are applicable in the context of general purpose computing systems, including desktop or laptop-based computer systems.

### TERMS AND CONCEPTS

The following is a description of various terms and phrases used herein. The descriptions are not intended as exclusive definitions, but rather are intended to provide illustrative examples to aid in the understanding of the described techniques.

Push Notification—includes content or other data passed (e.g., sent, transmitted) to a mobile device out-of-band with respect to any existing active data sessions, and may include or specify an action as part of the data. If an action is included or specified, a default or custom action may be taken or further data may be obtained and/or presented in response to a user action or selection.

Native Application—includes a native “app,” native system component, operating service component, kernel process, daemon, or other non-Web-based component running on a mobile device.

Originator—includes an entity, person, or system that creates a notification and whose content is consumed by the notification.

Registration Service—includes a Web service that keeps track of which users are registered to receive push notifications for which originators.

Pre-configuration Service—includes a Web service that stores data prior to installing a native application and communicates this data to the native application post-installation.

Relay Service—includes a Web service that receives content from an originator and forwards it to users who are registered to receive them. The content may be forwarded directly or indirectly, such as via a platform service (below).

Receiver—includes a native component that receives a push notification.

Payload—includes content of a push notification. The payload may include data for consumption and/or an identification of such data, such as via a URL or other type of link or reference.

Notification Action—includes actions that occur upon or in response to the opening of a push notification. A notification action may be a user action that results in the consumption of the originator's content, in a Web browser, video client (e.g., via YouTube), phone call, or the like.

Consumption—includes the consumption of the originator's content that is received and/or identified via a push notification.

Originator's Consumable—includes content that is viewed, listened, called, or the like, as a result of an action.

Platform Service—includes the service provided by each combination of mobile device, operating system vendor, service provider, and the like, that allows native push notifications to be transmitted to an installed base of mobile devices.

Web service—includes any system configured to support interoperable machine-to-machine interaction over a network. Furthermore, although various techniques are described herein with respect to Web services, the techniques are not limited to Web-based technologies or protocols (e.g., HTTP, HTML, XML). In particular, the described techniques may be implemented in whole or in part using technologies or protocols that are proprietary (e.g., closed), that use different data formats (e.g., binary), that use arbitrary or non-standard communication endpoints (e.g., TCP/IP ports), or the like.

### System Overview

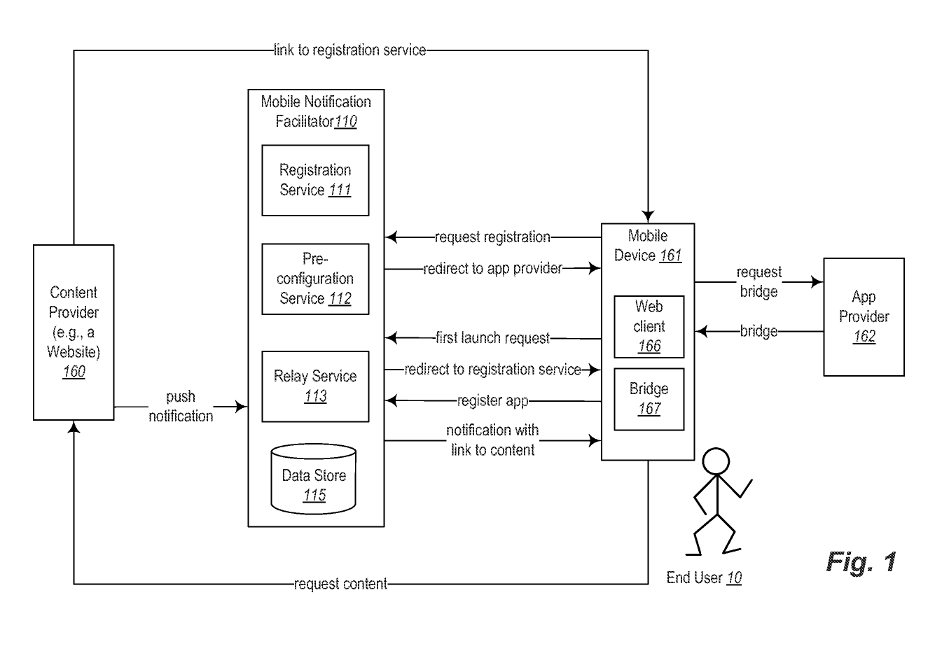

FIG. 1 is a block diagram of an example mobile notification facilitator according to an example embodiment. More specifically, FIG. 1 illustrates a Mobile Notification Facilitator (“MNF”) 110 that facilitates the delivery of push notifications from a content provider 160 to a mobile device 161 that is operated by an end user 10.

The illustrated MNF 110 includes a registration service 111, a pre-configuration service 112, a relay service 113, and a data store 115. As noted above, and as described further below, the registration service 111 tracks users and/or mobile devices that are registered to receive push notifications from associated content originators, such as the content provider 160. The pre-configuration service 112 manages pre-configuration processes, such as by storing configuration data before, during, and after installation of applications or modules on the mobile device 161.

The relay service 113 receives push notifications from the content provider 160 and forwards the received notifications to users and/or mobile devices that are registered to receive them. Typically, the relay service forwards the received notifications via a platform service (not shown). The platform service may be a service that is configured to deliver notifications to particular combinations of devices, operating systems, and/or service providers (e.g., Apple Push Notification Service or Cloud 2 Device Messaging on Android). In some embodiments, the platform service may be part of the relay service 113 and/or hosted or operated externally to the MNF 110.

The mobile device 161 includes a Web client (e.g., a Web browser or component) 166. The mobile device 161 also includes a bridging component denoted as bridge 167. The bridge 167 is installed and pre-configured by a process that is described in more detail below.

In the illustrated scenario, the content provider 160 provides a Website that is accessed by the user 10 operating the Web client 166. The content provider 160 additionally allows the user 10 to register the mobile device 161 for push notifications. To initiate registration for push notifications, the content provider 160 initially provides a link to a registration service. This link may be provided, for example, as part of a Web page that is accessed via the Web client 166. The link identifies the registration service 111 in addition to the content provider 160 and/or any associated configuration information that is related to the content provider 160. For example, the link may include or be otherwise based on a URL such as: “http://launch.alertrocket.com/register?appKey=58bf&tag=Sports&alias=News,” where “launch.altertrocket.com” identifies the MNF 110 or one of its constituent services, such as the registration service 111. The example URL also includes a number of key-value pairs that identify an application key, a tag, and an alias.

When the user 10 clicks on or otherwise selects the provided link, the Web client 166 makes a registration request to the registration service 111. The registration service 111 initially stores the link payload/data on the mobile device 161. For example, given the above URL, the registration service 111 may store, key, indicate, or identify the key-value pairs as or via an HTTP cookie with the Web client 166. In other embodiments, the registration service 111 may store the link payload/data at some other location that is accessible to the mobile device 161, such as a shared data repository, app provider, or the like.

Next, the registration service 111 redirects or otherwise causes the Web client 166 to access an app provider 162 to download and install a bridging component. For example, the registration service 111 may transmit an HTTP redirect that includes a URL that identifies a bridging component available at the app provider 162. In response, the Web client 166 accesses the app provider 162 and downloads and installs the bridge 167.

After installation and upon first execution of the bridge 167, the bridge causes the Web client 166 to transmit a first launch request to the MNF 110. For example, the bridge 167 may cause the Web client 166 to make an HTTP request based on a URL such as the following: “http://launch.alertrocket.com/installed.” The information that was previously stored or keyed as a cookie may also be transmitted to the MNF 110 as part of this HTTP request.

In response to the received first launch request, the MNF 110 causes control to pass to the bridge 167, which in turn completes any pre-configuration and registration. Typically, the MNF 110 causes this transfer of control via an HTTP redirect to a URL that uses a custom protocol mapping that causes the Web client 166 to execute and/or pass registration/configuration data to the bridge 167. For example, the MNF 110 may transmit an HTTP redirect that includes a URL such as “alertrocket://register?appKey=58bf&tag=Sports&alias=News.” This example URL identifies a protocol named “alertrocket.” The identified protocol causes the Web client 166 to execute and/or pass control to the bridge 167 along with any data incorporated into the URL, which in this case is the same configuration data that was initially stored as a cookie by the Web client 166. The bridge 167 uses this configuration data to complete registration and configuration, such as by registering to receive notifications from the MNF 110 and/or by registering with the appropriate native mobile alert or notification module of the operating system of the mobile device 161. Registering with the MNF 110 to receive push notifications will typically also include the bridge 167 transmitting an identifier or token of the mobile device 161 to the MNF 110, so that the MNF 110 can associate that identifier with push notifications provided from specific sources, such as content provider 160.

The above-described techniques facilitate installation and configuration of the bridge 167 to receive notifications from the content provider 160 with minimal or no interaction from the user 10. Specifically, the user 10 need not manually configure the bridge 167. Nor does the user have to return to or log into the content provider 160 after installation of the bridge 167. In at least some embodiments, the user 10 need only select the original link provided by the content provider 160, and possibly agree to installation of the bridge 167 from the app provider 162. Aside from these actions, the user 10 need not type or otherwise provide configuration information to the bridge 167.

Once the bridge 167 is installed, it can be configured, via additional registrations, to receive notifications from other content providers that are distinct from content provider 160. Thus, only a single bridge 167 need be installed to receive notifications from a diversity of content providers. For example, the user 10 may visit a second Web site that includes a registration link. When this link is processed by the Web client, a registration process similar to the above occurs, although without the need to first install the bridge 167, as it has been previously installed.

Note that while the described techniques are typically discussed herein with respect a bridging component or app (e.g., bridge 167), other embodiments may use at least some of these techniques to install, register, and/or pre-configure other types of software. For example, some embodiments may pre-configure native applications that may or may not rely on or process push notifications. In one embodiment, a news organization (e.g., CNN) may use the described pre-configuration techniques to provide different configurations of a single native application (e.g., a news client app). For example, depending on how or where the user requested the application, the application could be differently configured. If the user obtained the application in the context of an international news site or page, the application may be configured to provide international news. On the other hand, if the user obtained the application in the context of a sports news site or page, the application may be configured to provide sports news.

### Example Processes

In the following, various example processes are described to further illustrate techniques for facilitating push notifications, and to contrast those techniques to prior art approaches.

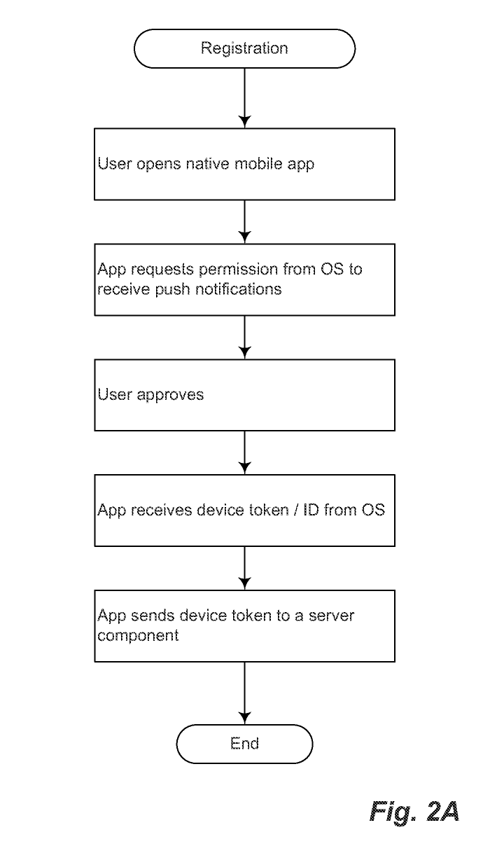

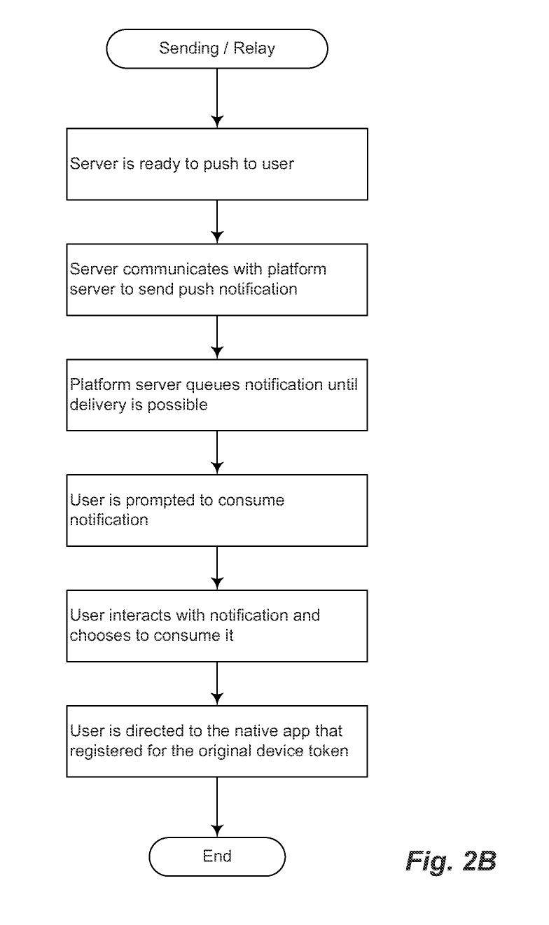

FIGS. 2A and 2B illustrate existing approaches to registration and transmission of push notification. More specifically, FIG. 2A depicts a process for registering for push notifications. In FIG. 2A, a user relies on a native mobile application that executes on a mobile device and that transmits a device token or other identifier to a notification server. The server then records the received device identifier, so that future push notifications may be transmitted to the mobile device, such as is described with reference to FIG. 2B.

In FIG. 2B, a server effectuates a push notification by communicating that notification to a platform server. The platform server queues or otherwise stores the notification until delivery is possible, such as when it is determined that a given destination mobile device is online. When delivery is possible, the platform server transmits the notification to the mobile device, where a corresponding user interacts with and consumes the notification.

Note that the processes of FIGS. 2A and 2B do not operate effectively in a Web-based context. In particular, receipt of notifications on a user mobile device may require installation and use of a native application that is specialized to a particular content provider. If the user desires to receive notifications from multiple distinct sources, he will typically be required to install a different native application for each source, along with performing the attendant manual configuration actions.

Registration

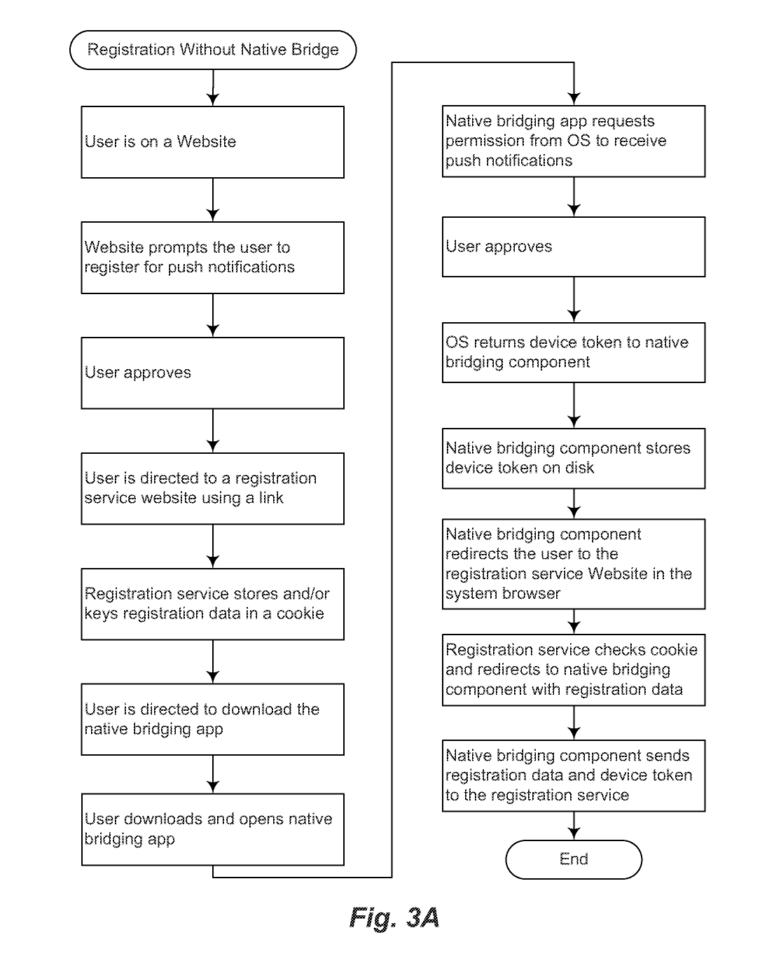

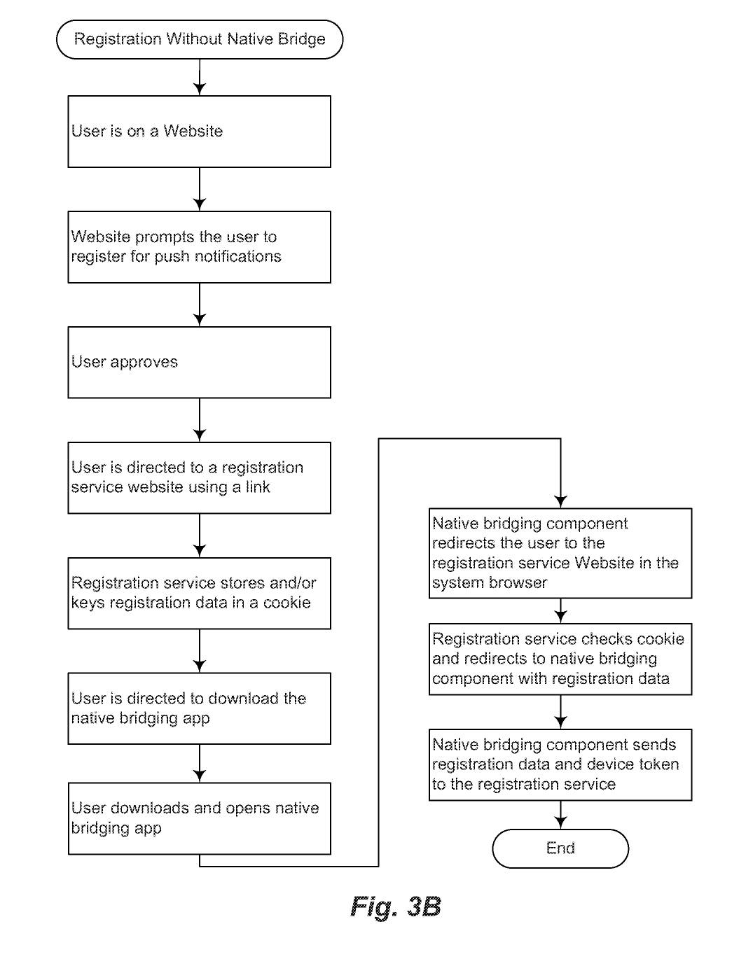

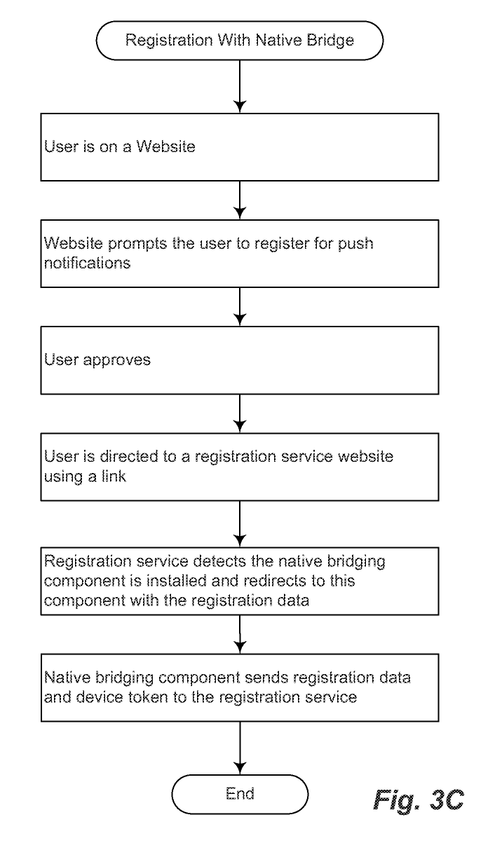

FIGS. 3A-3C depict registration processes according to example embodiments. In a typical registration scenario a user is on a Website and would like to receive push notifications from the Website. The Website will provide the user a link (e.g., a URL or an element that contains a URL) to the registration service 111. The link contains registration data and an identifier for the Website. In other embodiments, the registration data and/or identifier may be obtained in other ways, such as from within a META tag, using JavaScript, or other element on an HTML page.

After the user follows this link, the registration service 111 may use JavaScript to detect if the native mobile component (e.g., bridge 167) is installed. Other techniques for detecting if the native mobile component is installed are contemplated, including via a direct operating system call, examination of a registry or other data store that tracks installation information, or the like. As discussed further with respect to FIGS. 3A and 3B, if the native mobile component is not installed, the registration service will store the registration data with the pre-configuration service and redirect the user to download, install, and run the native mobile component. As discussed further with respect to FIG. 3C, if the native mobile component is installed, the user will be redirected directly into the native mobile component and the registration data communicated in this redirect.

Registration data includes Website identifier information as well as targeting information to allow the relay service 113 to target a subset of the registered users at once. Targeting information may include one or more tags, and one alias.

After (or as part of) pre-configuration the native mobile component will communicate the registration data and the mobile device ID obtained from the operating system to the registration service.

In typical embodiments, all or some registration information is stored in a cookie. A detection script is run on the mobile device to determine if the user has the native component installed and is either redirected to download the native component (FIGS. 3A and 3B) or directed into the shared native component (FIG. 3C). In either case, the native component may receive registration from the system browser (e.g., based on information previously stored in a cookie, based on arguments in a URL or other data passed to the native component from the system browser). The native component will then communicate the registration information to the relay service 113 to complete the registration to receive push notifications from the originator.

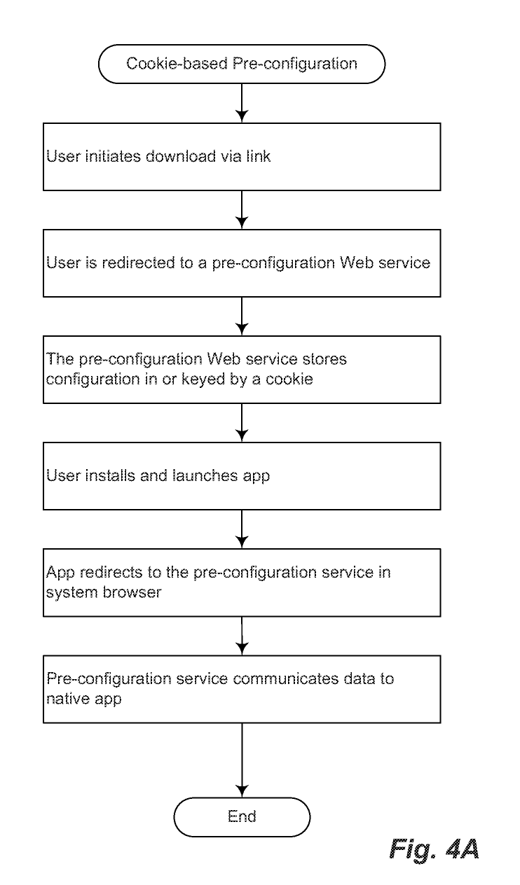

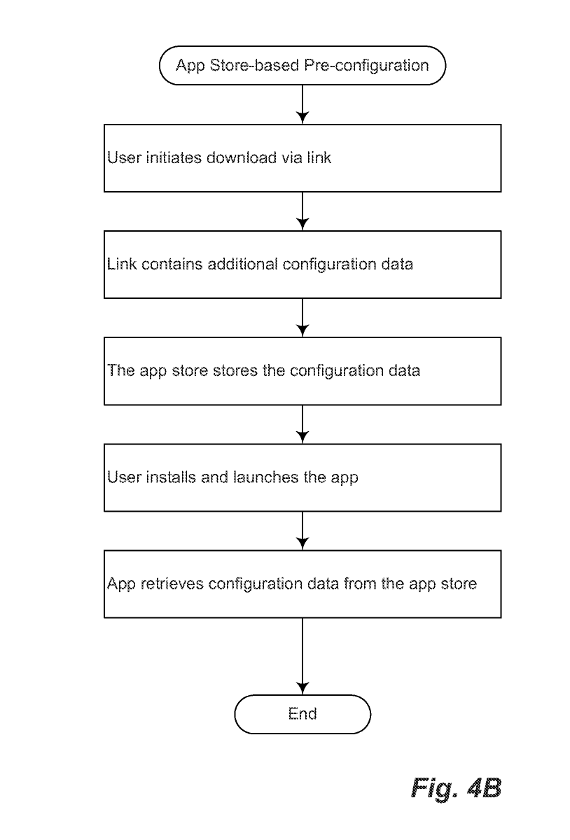

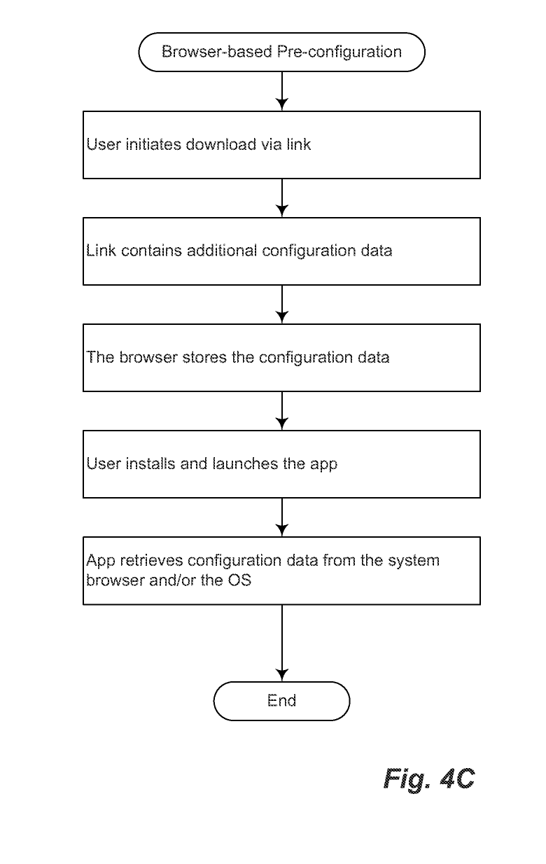

FIGS. 3A and 3B each illustrate a registration scenario similar to that discussed with reference to FIG. 1, where a native bridging component is not initially present and must be installed on a user's mobile device. As shown in FIG. 3A, the registration process is initiated via a registration link provided by a Website. In a typical embodiment, the link includes or is based on a URL that identifies a relay service and that contains the originating Website identifier and any extended registration information. This information is then handed off to a native component pre-configuration process, variations of which are discussed further below, with respect to FIGS. 4A-4C.

The process of FIG. 3A further causes a unique identifier (e.g., a device token) of the user's mobile device to be communicated to the relay service, along with the identifier of the originating Website and any extended registration information.

The process illustrated by FIG. 3B is similar to that of FIG. 3A, except that in FIG. 3B, the native bridging component does not request, and the user does not grant, permission to receive push notifications. Different mobile device operating systems (e.g., iOS, Android, Windows Phone) may utilize or provide differing installation sequences. More specifically, some operating systems (e.g., iOS) require an explicit grant of user permissions (an “opt-in”) after installation but prior to (or upon) first use of an installed app or component. In such circumstances, the process of FIG. 3A may be utilized. Other operating systems may obtain such permission at different times, in different ways, or not at all. For example, in the Android environment, the user is presented with a list of permissions to which she implicitly agrees by installing the app. In such circumstances, the process of FIG. 3B may be used.

FIG. 3C is directed to a registration scenario in which a bridging component has already been previously installed on a mobile device. As noted, a script or other code may be run on the mobile device to detect whether the bridging component has been previously installed. If so, there is no need to obtain the bridging component from the app provider 161 or other source. Instead, registration information may be passed to the bridging component (e.g., by way of a custom URL protocol), which then completes registration with respect to the given push notification provider.

Pre-Configuration

FIGS. 4A-4C depict pre-configuration processes according to example embodiments. In typical embodiments, a pre-configuration service 112 will store given pre-configuration data in a cookie that is stored in the system browser cookie storage mechanism. This cookie either contains the pre-configuration data or a key referencing the data in another storage mechanism. Once the user downloads and runs the native application being pre-configured, the native application will redirect to a URL on the pre-configuration service in the system browser. The pre-configuration service will check the existence of pre-configuration data for this mobile device and will communicate the information back to the native application using a custom URL protocol mapping. In either case, the native mobile application will be opened by the pre-configuration service.

FIG. 4A illustrates a first type of pre-configuration process that is based on cookie storage. In this variant, registration and/or configuration information can be stored or keyed (e.g., a session key) by a Web cookie and then later retrieved by the native bridging component by checking the in-app or system browser using a URL call to the pre-configuration service. The pre-configuration service will check the stored cookie and pass the information back to the native component using Web-to-native communication channels, such as via a custom protocol discussed with respect to FIG. 1, above.

FIG. 4B illustrates a second type of pre-configuration process that is based on storage in an app store. In this variant, the pre-configuration information may be stored by an app store (e.g., app provider 162) and then provided to the native component directly or through calls the native component makes to the mobile device operating system. The pre-configuration information may then be passed to the installed native component without requiring the native component to redirect to the system browser and instead implement a callback function, read a shared file, read shared memory, or perform some other native information passing function.

FIG. 4C illustrates a third type of pre-configuration process that is based on storage in a system browser or other type of Web client. In this variant, pre-configuration information may be stored by the system browser or through calls it makes to the mobile device operating system before redirecting the user to download the native component in the app store. The native component would then retrieve the information from the operating system, an in-app browser, the system browser component, or other native information passing function.

Other and/or additional pre-configuration processes are contemplated, possibly based on combinations of the above techniques. In one example embodiment, a user interface control (e.g., button, link, banner) is presented in a Web page or other content item rendered by the system browser or other Web client executing on the mobile device. This user interface control is generated by the browser based on information obtained from the Web page, such as may be represented by a link, tag, or similar element. The information from the Web page may include an app identifier (e.g., a URL or other identifier of an app available from an app store) in addition to pre-configuration information. When the user selects (e.g., clicks) on the generated user interface control, the system browser initiates a download of the specified app from a corresponding app store. After installation and upon first launch, the system browser passes the pre-configuration information to the installed app. In some embodiments, the pre-configuration information may be encoded or identified by a URL that possibly uses a custom URL protocol and/or encodes/identifies the pre-configuration information via URL-encoded arguments. In such cases, the system browser can pass the pre-configuration information by passing the custom URL to the installed app.

Sending of Web Push Notifications

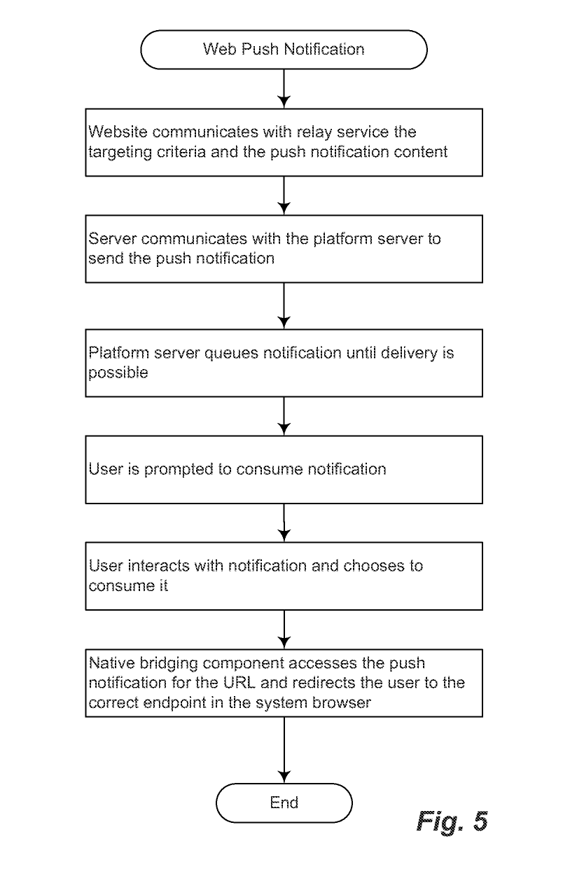

FIG. 5 depicts a push notification process according to an example embodiment. As shown in the process of FIG. 5, a Web site or other originator initially communicates a push notification to the relay service 113. An originator can originate a push notification using several mechanisms: a Web-service API call, an entry in an RSS (“Rich Site Summary,” “Really Simple Syndication,” or similar web news feed protocol), manually through a UI or other Web mechanism. The push notification will then be relayed by the relay service 113 to a targeted subset of or a broadcast to all registered users of the originator.

The relay service 113 will determine along with the registration service 111 which users should receive a particular notification and communicate each push notification to the platform push notification service. The platform notification service will communicate the push notification via the described shared native bridging component.

Upon a determination that a push is to be sent, the registration service will determine the correct platform service to communicate with, and the push content itself may be rewritten or translated into an appropriate format in a rules-based manner. For example, a push may be specified or represented using a particular JSON (JavaScript Object Notation) structure, and the push may be rewritten to another JSON structure that is appropriate for or otherwise suited to a particular platform service (e.g., iOS or Android). In some cases, the push may be translated between different representation formats, such as JSON to XML, XML to JSON, JSON to a binary format, or the like.

Data length is understood to be significant factor in the mobile industry. Accordingly, rewriting rules include provisions to not duplicate data either on input or output (or first format or second format). For example, if an original data structure or representation specifies or sets a title (or any other element) in one place or position, that element should not be duplicated in the rewritten or translated data structure.

Relaying a push notification may include pushing or otherwise transmitting the notification to one or more mobile devices using a corresponding operating system specific platform service (e.g., Apple Push Notification Service or Cloud 2 Device Messaging on Android) or using a custom daemon to poll the relay service where an operating system specific platform service is not supported.

Once the notification has been received and presented by a mobile device, the user can then choose to take an action on the originator's content. The action may vary on a notification-by-notification basis. The action may include one or more of opening of a Website, initiating a telephone phone call, opening a third-party app (e.g., a video viewer, a map app), or other URL-based action.

Some embodiments are directed to an alternative Web-based push notification implementation using the native system browser, which is based upon the browser that ships with the mobile device. In this embodiment, the above-described process may be replaced by a native implementation inside the system browser. This may include the system browser (or some other native component on the browser's behalf) signing up for notifications with the operating system and exposing the registration functionality to the originating Website via JavaScript or custom URLs. The system browser would then communicate a registration ID back to the originating site that it could use to send notifications using the platform native platform service (e.g., Apple Push Notification Service or Cloud 2 Device Messaging on Android). When a user indicates that they want to take an action on a notification, the system browser opens the URL sent in the notification, thereby causing the corresponding action to occur (e.g., based on a particular URL protocol). For example, the corresponding action may be to open a video player, telephony app/component, or the like.

In addition, some embodiments provide a modified mobile device Web browser that facilitates registration to Web news feeds provided via Web sites or other sources. For example, the modified Web browser may detect the presence or availability of a news feed (e.g., by detecting an RSS link) and provide a control (e.g., a button) that can be selected by the user to register for notifications based on the news feed. When the user clicks the button, the Web browser may initiate one or more of the registration and/or pre-configuration processes described herein, including installing a native bridging component.

Note that embodiments may perform variations of the processes illustrated by the flow diagrams of FIGS. 2-5. In particular, in some embodiments one or more steps or blocks may be omitted. Furthermore, blocks may be in some cases performed in different orders and/or combined with one another.

### Example Computing System Implementation

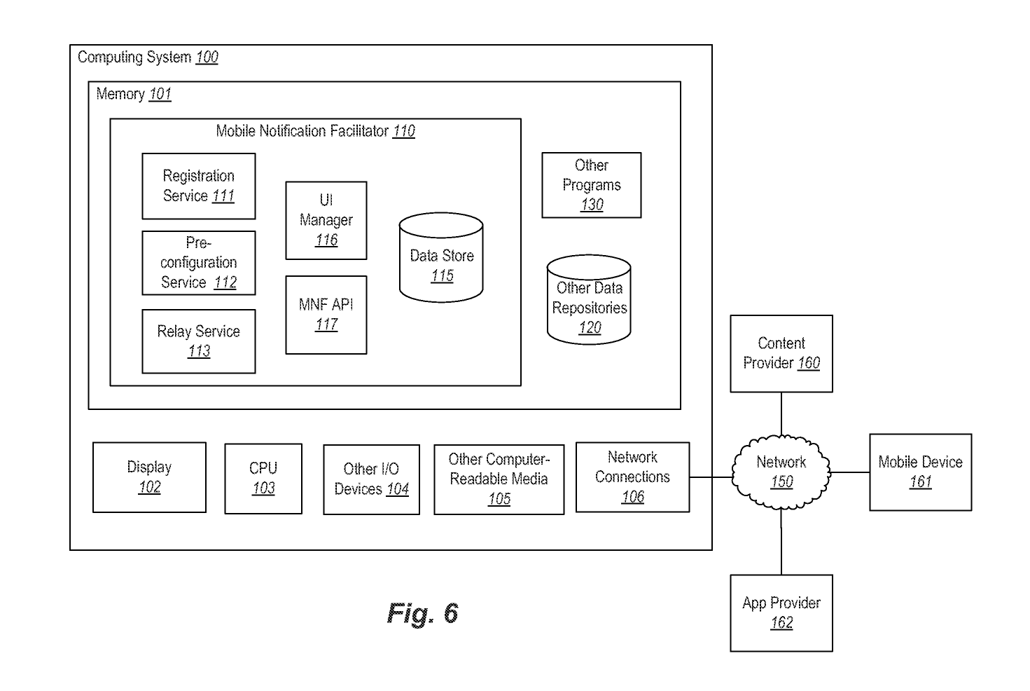

FIG. 6 is a block diagram of an example computing system for implementing a mobile notification facilitator according to an example embodiment. In particular, FIG. 6 shows a computing system 100 that may be utilized to implement a mobile notification facilitator (“MNF”) 110.

Note that one or more general purpose or special purpose computing systems/devices may be used to implement the MNF 110. In addition, the computing system 100 may comprise one or more distinct computing systems/devices and may span distributed locations. Furthermore, each block shown may represent one or more such blocks as appropriate to a specific embodiment or may be combined with other blocks. Also, the MNF 110 may be implemented in software, hardware, firmware, or in some combination to achieve the capabilities described herein.

In the embodiment shown, computing system 100 comprises a computer memory (“memory”) 101, a display 102, one or more Central Processing Units (“CPU”) 103, Input/Output devices 104 (e.g., keyboard, mouse, CRT or LCD display, and the like), other computer-readable media 105, and network connections 106 connected to a network 150. The MNF 110 is shown residing in memory 101. In other embodiments, some portion of the contents, some or all of the components of the MNF 110 may be stored on and/or transmitted over the other computer-readable media 105. The components of the MNF 110 preferably execute on one or more CPUs 103 and perform one or more of the processes described herein. Other code or programs 130 (e.g., an administrative interface, a Web server, and the like) and potentially other data repositories, such as data repository 120, also reside in the memory 101, and preferably execute on one or more CPUs 103. Of note, one or more of the components in FIG. 6 may not be present in any specific implementation. For example, some embodiments may not provide other computer readable media 105 or a display 102.

The MNF 110 includes the registration service 111, pre-configuration service 112, relay service 113, and data store 115 described with respect to FIG. 1. The MNF 110 also includes a user interface (“UI”) manager 116 and mobile notification facilitator application program interface (“API”) 117.

The UI manager 116 provides a view and a controller that facilitate user interaction with the MNF 110 and its various components. For example, the UI manager 116 may provide interactive access to the MNF 110, such that administrators or customers can register new push notification types, generate new push notifications, modify registration information, modify operation of the pre-configuration service 112, or the like. In some embodiments, access to the functionality of the UI manager 116 may be provided via a Web server, possibly executing as one of the other programs 130. In such embodiments, a user operating a Web browser (or other client) executing a client device (e.g., mobile device 161) can interact with the MNF 110 via the UI manager 116. For example, a user associated with the content provider 160 may initiate a new push notification via a form or other set of controls provided via the UI manager 116.

The API 117 provides programmatic access to one or more functions of the MNF 110. For example, the API 117 may provide a programmatic interface to one or more functions of the MNF 110 that may be invoked by one of the other programs 130 or some other module. In this manner, the API 117 facilitates the development of third-party software, such as user interfaces, plug-ins, news feeds, adapters (e.g., for integrating functions of the MNF 110 into Web applications), and the like. In addition, the API 117 may be in at least some embodiments invoked or otherwise accessed via remote entities, such as the mobile device 161 or content provider 160, to access various functions of the MNF 110. For example, the content provider 160 may transmit to the relay service 113 a push notification to be relayed to mobile device 160 via the API 117.

The data store 115 is used by the other modules of the MNF 110 to store and/or communicate information. The components of the MNF 110 use the data store 115 to record various types of information, including registration information, device identifiers, push notifications, distribution information (e.g., associations between mobile device identifiers and push notification types), and the like. Although the components of the MNF 110 are described as communicating primarily through the data store 115, other communication mechanisms are contemplated, including message passing, function calls, pipes, sockets, shared memory, and the like.

The MNF 110 interacts via the network 150 with the content provider 160, the mobile device 161, and the app provider 162. The network 150 may be any combination of one or more media (e.g., twisted pair, coaxial, fiber optic, radio frequency), hardware (e.g., routers, switches, repeaters, transceivers), and one or more protocols (e.g., TCP/IP, UDP, Ethernet, Wi-Fi, WiMAX) that facilitate communication between remotely situated humans and/or devices. In some embodiments, the network 150 may be or include multiple distinct communication channels or mechanisms (e.g., cable-based and wireless). The mobile device 161 may be or include a smart phone, feature phone, tablet computer, laptop computer, or the like. In other embodiments, the described techniques may be employed in the context of fixed computing systems, such as desktop computers, kiosk systems, or the like.

The mobile device 161 may be or include computing systems and/or devices constituted in a manner similar to that of computing system 100, and thus may also include displays, CPUs, other I/O devices (e.g., a camera), network connections, or the like. Furthermore, the techniques for implementing the MNF 110 may be similarly employed for implementing the native bridging component (e.g., bridge 167) for execution on the mobile device 161.

In an example embodiment, components/modules of the MNF 110 are implemented using standard programming techniques. For example, the MNF 110 may be implemented as a “native” executable running on the CPU 103, along with one or more static or dynamic libraries. In other embodiments, the MNF 110 may be implemented as instructions processed by a virtual machine that executes as one of the other programs 130. In general, a range of programming languages known in the art may be employed for implementing such example embodiments.

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the MNF 110, such as in the data store 115, can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 115 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in certain embodiments, some or all of the components of the MNF 110 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored in a non-transitory manner on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “includes,” “including,” “comprises,” and “comprising” should be interpreted as referring to elements, components, or steps in a non-exclusive manner, indicating that the referenced elements, components, or steps may be present, or utilized, or combined with other elements, components, or steps that are not expressly referenced. Where the written description and/or claims refer to at least one of something selected from the group consisting of A, B, C . . . and N, the text should be interpreted as requiring at least one element from the group (A, B, C . . . N), not A plus N, or B plus N, etc.

All of the above-cited references, including U.S. Provisional Application Ser. No. 61/566,303, entitled “METHOD AND SYSTEM FOR SENDING PUSH NOTIFICATION” and filed Dec. 2, 2001, are incorporated herein by reference in their entireties. Where a definition or use of a term in an incorporated reference is inconsistent or contrary to a definition or use of that term provided herein, the definition or use of that term provided herein governs.

While one or more embodiments of the invention have been illustrated and described above, many changes can be made without departing from the spirit and scope of the invention. Accordingly, the scope of the invention is not limited by the disclosure of any particular embodiment. Instead, the invention should be determined entirely by reference to the claims that follow.

1. A method for facilitating delivery of notifications from a content provider to a mobile device, the method comprising:
installing a bridging component that is configured to receive notifications from multiple distinct content providers that each communicate notifications through a mobile notification facilitator service;
receiving from the mobile notification facilitator service a notification that originates from one of the multiple content providers, the notification including an indication of an action to be performed upon consumption of the notification, the action including invoking a code module that is distinct from the bridging component;
presenting the notification to a user of the mobile device; and
upon receiving an indication that the user consumes the notification, performing the action by invoking the distinct code module to obtain content from the content provider.

2. The method of claim 1, wherein performing the action includes at least one of:
accessing the content via a Web browser of the mobile device;
accessing a video via a video player of the mobile device;
initiating a telephone call via a telephony component of the mobile device;
accessing a map of a specified location via a map application of the mobile device; and
accessing the content via a custom application that is installed on the mobile device and that is provided by the content provider.

3. The method of claim 1, wherein installing the bridging component includes pre-configuring the bridging component, by:
prior to installing the bridging component, receiving and storing configuration information from the mobile notification facilitator service;
during an initial execution occurring after installation of the bridging component, providing the stored configuration information to the bridging component.

4. The method of claim 3,
wherein the bridging component is a native component that is distinct from and does not execute within a Web browser installed on the mobile device,
wherein receiving and storing configuration information includes:
receiving and storing an HTTP cookie that contains the configuration information, the cookie received from the mobile notification facilitator service, and
wherein providing the stored configuration information includes:
transmitting, via the Web browser, a request to the mobile notification facilitator service, the request including the configuration information from the stored cookie; and
receiving from the mobile notification facilitator service a redirect that includes a uniform resource locator specifying a custom uniform resource locator protocol that causes the Web browser to provide the configuration information to the bridging component.

5. The method of claim 3, wherein receiving and storing configuration information includes:
receiving from the content provider a uniform resource locator that identifies the mobile notification facilitator service and that identifies the configuration information; and
in response to a request based on the uniform resource locator, receiving an HTTP cookie that contains the configuration information and receiving a redirect to an application provider that hosts the bridging component.

6. The method of claim 3, further comprising:
receiving information that identifies an application provider and that includes a parameter that identifies the configuration information, wherein the application provider makes the bridging component available for download; and
receiving, by the bridging component, the parameter after installation of the native bridging component.

7. The method of claim 6, wherein the application provider stores the parameter, and wherein receiving the parameter includes receiving the parameter from the application provider is via a native function call, native function callback, and/or a Web service.

8. The method of claim 6, wherein the parameter is a uniform resource locator that includes configuration arguments, and wherein receiving the parameter includes receiving the uniform resource locator from a Web browser that is installed on the mobile device and that renders a Web page that includes the information that identifies the application provider and that includes the parameter.

9. The method of claim 3, wherein the bridging component is a component that executes within a Web browser installed on the mobile device, and wherein pre-configuring the bridging component is performed without control leaving the Web browser.

10. The method of claim 3, after installation and configuration of the bridging component, automatically returning to a Web site hosted by the content provider.

11. The method of claim 3, wherein the configuration includes a device token or identifier that is unique to the mobile device, an identifier of the content provider, and extended notification data including an alias and one or more tags.

12. The method of claim 1, wherein the mobile device includes a Web browser that is configured to register to receive push notifications based on Web news feeds accessed via Web sites by:
in response to viewing a page that includes or references a Web news feed, presenting a control configured to initiate registration to the Web news feed; and
in response to a user selection of the control, initiating a registration process that includes installing and pre-configuring the bridging component.

13. A method in a mobile notification facilitator service, the method comprising:
providing a bridging component configured for installation on mobile devices, the bridging component configured to facilitate delivery of push notifications transmitted from multiple distinct content providers via the mobile notification facilitator service to the mobile device;
during installation of the bridging component on a mobile device, pre-configuring the bridging component by:
transmitting a cookie to a Web browser executing on the mobile device, the cookie containing configuration information that identifies one of the content providers;
causing the Web browser to provide the configuration information to the bridging component; and
in response to a received registration request from the bridging component, associating the mobile device with the content provider; and
transmitting a push notification from the content provider to the mobile device, based on the association of the mobile device with the content provider.

14. The method of claim 13, wherein transmitting the push notification includes receiving a notification that an entry has been added to a Web news feed of the content provider, that a notification has been provided via a user interface of the mobile notification facilitator service, and/or that a notification has been provided via a Web service of the mobile notification facilitator service.

15. The method of claim 14, wherein transmitting the push notification includes forwarding the notification to multiple platform services that are each configured to transmit notifications to a corresponding type of mobile device operating system.

16. The method of claim 13, wherein transmitting the push notification includes:
receiving the push notification from the content provider, wherein the push notification is represented in a first format;
translating the push notification into a second format according to one or more rules associated with a platform service that is configured to transmit notifications to a corresponding type of mobile device operating system; and
forwarding the push notification in the second format to the platform service.

17. The method of claim 16, wherein translating the push notification includes, for each entry in the push notification in the first format, including only one corresponding entry in the push notification in the second format, such that there are no duplicated entries in the push notification in the second format.

18. The method of claim 13, wherein causing the Web browser to provide the configuration information to the bridging component includes transmitting a redirect to the Web browser, the redirect including uniform resource locator that includes a custom protocol that causes the Web browser to provide the configuration information to the bridging component.

19. The method of claim 13, wherein the bridging component executes within the Web browser, and wherein the bridging component is configured to facilitate registration for push notifications without requiring installation of a native application or component separate from the Web browser.

20. A non-transitory computer-readable medium storing a bridging component including instructions that are configured, when executed by a mobile computing device, to perform a method comprising:
during installation and first use of the bridging component,
receiving, from a Web browser of the mobile computing device, registration information for registering for push notifications provided by a content provider, the registration information provided to the Web browser as part of a uniform resource locator received from a mobile notification facilitator service, the uniform resource locator including a custom protocol that causes the Web browser to pass the registration information to the bridging component; and
transmit the registration information along with an identifier of the mobile device to the mobile notification facilitator service to cause the mobile notification facilitator service to provide notifications from the content provider to the mobile device.

21. The computer-readable medium of claim 20, wherein the method further comprises:
installing the bridging component;
notifying the mobile notification facilitator service of an initial use of the bridging component; and
receiving from the mobile notification facilitator service a redirect that includes a uniform resource locator that causes the Web browser to pass registration information to the bridging component.

22. The computer-readable medium of claim 20, wherein the method further comprises:
determining whether the bridging component is already installed; and
if the bridging component is already installed, passing the registration information to the bridging component without first installing the bridging component.
